(19) United States
(12) Patent Application Publication
(10) Pub. No.: US 2019/0039025 A1
(43) Pub. Date: Feb. 7, 2019

(54) FILTER UNIT

(71) Applicant: SUMITOMO ELECTRIC INDUSTRIES, LTD., Osaka-shi, Osaka (JP)

(72) Inventors: Hiromu TANAKA, Sennan-gun, Osaka (JP); Tomoyuki YONEDA, Sennan-gun, Osaka (JP); Hiroko MIKI, Sennan-gun, Osaka (JP); Toru MORITA, Sennan-gun, Osaka (JP)

(73) Assignee: SUMITOMO ELECTRIC INDUSTRIES, LTD., Osaka-shi, Osaka (JP)

(21) Appl. No.: 15/757,711

(22) PCT Filed: Oct. 5, 2016
(86) PCT No.: PCT/JP2016/079636

§ 371 Date: Mar. 6, 2018

(30) Foreign Application Priority Data
Oct. 8, 2015 (JP) 2015-200603

(51) Int. Cl. B01D 65/02; B01D 63/04

(52) U.S. Cl. CPC B01D 65/02; B01D 2321/185; B01D 2319/04; B01D 63/043

(57) ABSTRACT

An object of the present invention is to provide a filter unit in which hollow fiber membranes can be effectively cleaned. A filter unit of the present invention includes a plurality of filtration modules and one or more air bubble generation modules that supply bubbles to the filtration modules from below. Each filtration modules includes a plurality of hollow fiber membranes extending in an up-down direction and arranged side by side in a curtain shape and which are arranged at intervals. The one or more air bubble generation modules supply coarse bubbles to the filtration modules.

### TECHNICAL FIELD

The present invention relates to a filter unit.

### BACKGROUND ART

Filter units including filtration modules, in which a plurality of hollow fiber membranes are bundled together, are used as solid-liquid separation treatment apparatuses in sewage treatment and manufacturing processes of pharmaceuticals etc.

Such a filter unit is immersed in untreated liquid when used, and performs a filtration process by blocking impurities contained in the untreated liquid at the surfaces of the hollow fiber membranes and allowing components other than the impurities to permeate into the inside of the hollow fiber membranes.

As described in, for example, Japanese Unexamined Patent Application Publication No. 2013-56346, the filter unit includes a plurality of filtration modules, each including a plurality of hollow fiber membranes extending in an up-down direction and arranged side by side, an upper holding member (water-collecting header) connected to upper openings of the hollow fiber membranes, and a lower holding member (holder) that holds lower portions of the hollow fiber membranes. The filter unit is configured such that filtered liquid that has permeated into the inside of the hollow fiber membranes of the filtration modules can be extracted through a water-collecting pipe connected to the upper holding members.

The filter unit also includes a pressurized-gas supply pipe that is disposed the filtration modules and that has a plurality of gas jetting holes. This filter unit is configured such that impurities that have adhered to the surfaces of the hollow fiber membranes can be removed by supplying gas to the filtration modules through the pressurized-gas supply pipe.

### CITATION LIST

### Patent Literature

PTL 1: Japanese Unexamined Patent Application Publication No. 2013-56346

### SUMMARY OF INVENTION

A filter unit according to an aspect of the present invention includes a plurality of filtration modules and one or more air bubble generation modules that supply bubbles to the filtration modules from below. Each filtration modules includes a plurality of hollow fiber membranes extending in an up-down direction and arranged side by side in a curtain shape and which are arranged at intervals. The one or more air bubble generation modules supply coarse bubbles to the filtration modules.

### BRIEF DESCRIPTION OF DRAWINGS

FIG. 1 is a schematic side view of a filter unit according to an embodiment of the present invention.

FIG. 2 is a schematic perspective view of filtration modules and a frame included in the filter unit illustrated in FIG. 1.

FIG. 3 is a schematic front view of a filtration module included in the filter unit illustrated in FIG. 1.

FIG. 4 is a schematic side view of the filtration module illustrated in FIG. 3.

### DESCRIPTION OF EMBODIMENTS

### Problem to be Solved by Present Invention

In the filter unit described in the above publication, relatively fine bubbles are ejected from below. However, bubbles having small volumes are easily caused to flow along with circulation in a tank, and tend to come into contact with the hollow fiber membranes unevenly. Therefore, there is a risk that some portions of the surfaces of the hollow fiber membranes will be left uncleaned. In addition, when the bubbles have small volumes, there is a risk that the impurities cannot be sufficiently removed because the pressure applied to the hollow fiber membranes when the surfaces thereof are abraded by the bubbles is low.

The present invention has been made in light of the above-described circumstances, and its object is to provide a filter unit in which the hollow fiber membranes can be efficiently cleaned.

### Advantageous Effects of Present Invention

According to a filter unit of the present invention, hollow fiber membranes can be efficiently cleaned.

### Description of Embodiments of Present Invention

Embodiments of the present invention will be described first.

A filter unit according to an aspect of the present invention includes a plurality of filtration modules and one or more air bubble generation modules that supply bubbles to the filtration modules from below. Each filtration modules includes a plurality of hollow fiber membranes extending in an up-down direction and arranged side by side in a curtain shape and which are arranged at intervals. The one or more air bubble generation modules supply coarse bubbles to the filtration modules.

In the filter unit, since the coarse bubbles are supplied to the filtration modules which each include a plurality of hollow fiber membranes, the bubbles move upward while being in contact with the surfaces of the hollow fiber membranes. The coarse bubbles move upward at a higher speed than fine bubbles, and therefore moves in a direction relatively close to the vertical direction in a tank. In addition, the coarse bubbles apply a high pressure to the surfaces of the hollow fiber membranes, and are therefore capable of effectively cleaning the surfaces of the hollow fiber membranes at a relatively high abrasion pressure. Thus, in the filter unit, the hollow fiber membranes can be uniformly and efficiently cleaned. Here, the term “coarse bubbles” means bubbles whose minimum width in a horizontal direction is greater than the average outer diameter of the hollow fiber membranes.

Preferably, no member that blocks an upward movement of the bubbles is provided between the filtration modules. The hollow fiber membranes that are closer to the outer periphery of each filtration module more easily allow the impurities to adhere thereto. Therefore, when the upward movement of the bubbles is not blocked in the spaces between the filtration modules, the hollow fiber membranes at the outer periphery of each filtration module can be efficiently cleaned by the coarse bubbles. In addition, when there is no blocking member, the bubbles move vertically upward at substantially uniform intervals. Accordingly, non-uniform cleaning does not easily occur.

An average horizontal diameter of the bubbles is preferably in a range from 10 mm to 250 mm. When the average horizontal diameter of the coarse bubbles is within this range, the cleaning effect for the hollow fiber membranes can be enhanced. Here, the term “average horizontal diameter of the bubbles” means the average value of minimum widths of the bubbles in the horizontal direction immediately before the bubbles discharged from the air bubble generation modules come into contact with the hollow fiber membranes or holding members that hold the hollow fiber membranes.

Preferably, the air bubble generation modules have bubble discharge holes having a circular shape, an elliptical shape, or a rectangular shape. When the bubble discharge holes in the air bubble generation modules have a circular shape, an elliptical shape, or a rectangular shape, the bubble discharge holes capable of supplying coarse bubbles can be relatively easily formed.

Preferably, the bubble discharge holes have an oblong shape. When the bubble discharge holes have an oblong shape, the hollow fiber membranes can be more effectively cleaned by, for example, arranging the bubble discharge holes so that long sides of the bubble discharge holes are parallel to an arrangement direction in which the hollow fiber membranes are arranged.

Preferably, a length of the long sides of the bubble discharge holes is in a range from 20 mm to 60 mm, and a ratio of the length of the long sides to a length of short sides of the bubble discharge holes is in a range from 2 to 8. When the length of the long sides of the bubble discharge holes and the ratio of the length of the long sides to the length of the short sides of the bubble discharge holes is in the above-described ranges, the cleaning effect for the hollow fiber membranes can be further enhanced.

Preferably, the bubble discharge holes have a circular shape or an elliptical shape. In addition, preferably, an average diameter of the bubble discharge holes in the air bubble generation modules is in a range from 10 mm to 50 mm. When the bubble discharge holes have a circular shape or an elliptical shape and the average diameter of the bubble discharge holes in the air bubble generation modules is in the above-described range, the coarse bubbles can be easily formed, and the cleaning effect for the hollow fiber membranes can be enhanced. Here, the term “average diameter of the bubble discharge holes” means the average value of the diameters of circles having the same area as the bubble discharge holes.

Preferably, the air bubble generation modules supply the bubbles intermittently. When the air bubble generation modules supply the bubbles intermittently, the coarse bubbles can be easily formed by a simple structure.

Preferably, the filtration modules are arranged at equal intervals at least in a transverse direction. In addition, preferably, an average interval between the filtration modules that are adjacent to each other in the transverse direction is in a range from 15 mm to 30 mm. When the filtration modules are arranged at equal intervals in the transverse direction and the average interval is in the above-described range, the hollow fiber membranes can be more effectively cleaned by the coarse bubbles without greatly increasing the size of the device. Here, the term “equal intervals” means that the differences between the intervals are within 10%, and more preferably 5%.

Preferably, an existence density of the hollow fiber membranes included in the filtration modules is in a range from 4 per square centimeter to 15 per square centimeter. When the existence density of the hollow fiber membranes is in the above-described range, the cleaning effect can be further enhanced with less increase in the size of the device.

In this specification, “up” means “up” relative to the filter unit according to the present invention in a used state (state in which the filter unit is immersed in the untreated liquid), and “down” is the opposite of “up”. The phrase “hollow fiber membranes are arranged in a curtain shape” means that the region in which the hollow fiber membranes are present has a long axis in a cross section perpendicular to the up-down direction.

### Detailed Description of Embodiment of Present Invention

A filter unit according to an embodiment of the present invention will now be described with reference to the drawings.

[Filter Unit]

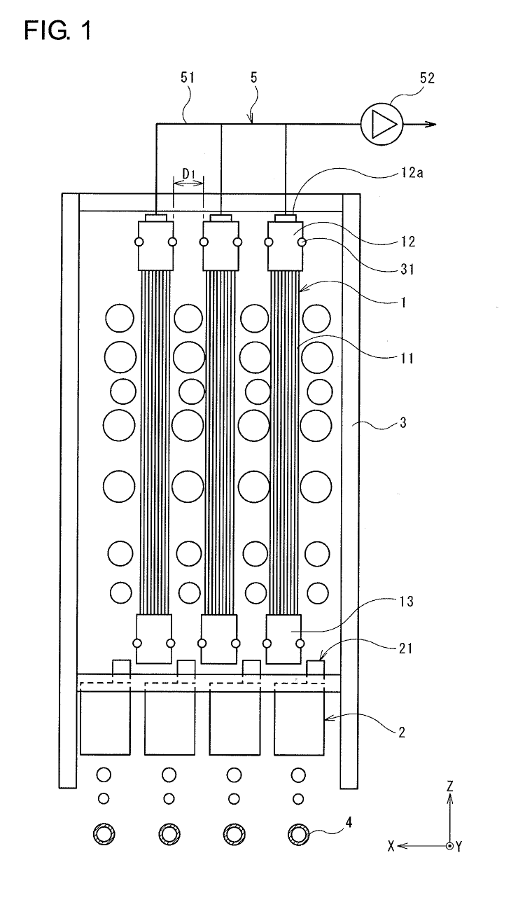

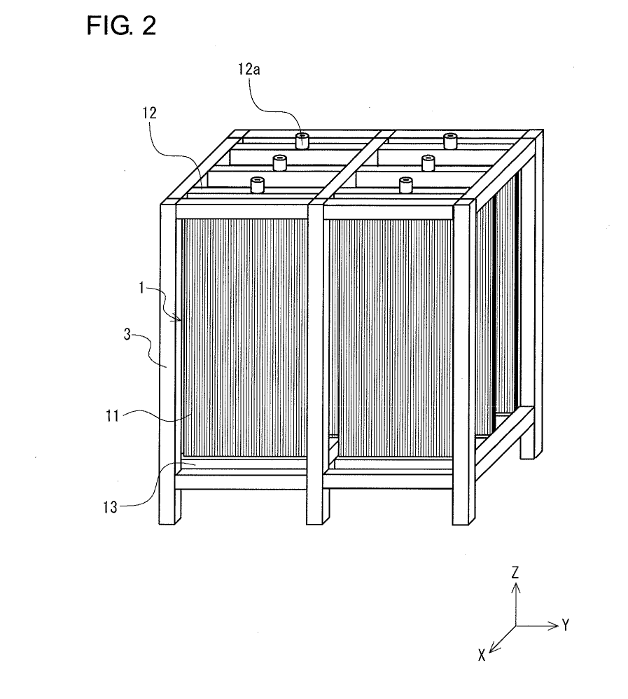

A filter unit illustrated in FIG. 1 includes a plurality of filtration modules 1 and a plurality of air bubble generation modules 2. Each filtration module 1 includes a plurality of hollow fiber membranes 11 extending in an up-down direction and arranged side by side in a curtain shape, an upper holding member 12 to which the top ends of the hollow fiber membranes 11 are fixed, and a lower holding member 13 to which the bottom ends of the hollow fiber membranes 11 are fixed. The air bubble generation modules 2 supply bubbles to the filtration modules 1 from below. The filter unit illustrated in FIG. 1 also includes a frame 3 that holds the filtration modules 1 and the air bubble generation modules 2, a plurality of diffuser tubes 4 that supply gas to the air bubble generation modules 2, and a discharge mechanism 5 that discharges treated liquid that has been filtered by the filtration modules 1. Each of the upper holding members 12 and the lower holding members 13 is rod-shaped. In each filtration module 1, the longitudinal direction of the upper holding member 12 and the lower holding member 13 is parallel to the long axis of the region in which the hollow fiber membranes 11 are present in a cross section perpendicular to the up-down direction. As illustrated in FIG. 2, each filtration module 1 is plate-shaped. The filtration modules 1 are arranged in parallel at intervals. In the following description, the longitudinal direction of the upper holding member 12 and the lower holding member 13 is referred to also as a Y direction, an opposing direction in which the upper holding member 12 and the lower holding member 13 oppose each other (up-down direction) is referred to also as a Z direction, and a direction perpendicular to the longitudinal direction and the opposing direction (transverse direction) is referred to also as an X direction.

The filter unit is immersed in untreated liquid when used. The filter unit performs a filtration process by preventing impurities contained in the untreated liquid from permeating into the inside of the hollow fiber membranes 11 and allowing components other than the impurities to permeate into the hollow fiber membranes 11.

(Air Bubble Generation Modules)

The air bubble generation modules 2 supply coarse bubbles to the filtration modules 1. The coarse bubbles move upward at a higher speed than fine bubbles in a direction relatively close to the vertical direction in a tank. The coarse bubbles apply a high pressure to the surfaces of the hollow fiber membranes 11, and are therefore capable of effectively cleaning the surfaces of the hollow fiber membranes 11 at a relatively high abrasion pressure. The minimum width of the coarse bubbles in a horizontal direction is preferably greater than or equal to three times the average outer diameter of the hollow fiber membranes.

The air bubble generation modules 2 have bubble discharge holes 21 that face upward. The air bubble generation modules 2 are configured so as to be capable of receiving gas discharged from the diffuser tubes 4 and discharging the gas upward from the bubble discharge holes 21.

The configuration of the air bubble generation modules 2 is not particularly limited as long as the gas can be discharged from the bubble discharge holes 21 in the form of coarse bubbles, and may be, for example, perforated pipes that continuously discharge the introduced gas through the bubble discharge holes 21. However, the air bubble generation modules 2 are preferably configured so as to be capable of intermittently discharging the bubbles. When the bubbles are intermittently discharged, coarse bubbles can be easily and more reliably formed by a simple structure. Continuous discharge devices and intermittent discharge devices may be used together.

The lower limit of the average horizontal diameter of the coarse bubbles supplied by the air bubble generation modules 2 is preferably 10 mm, more preferably 20 mm, and still more preferably 50 mm. The upper limit of the average horizontal diameter of the coarse bubbles supplied by the air bubble generation modules 2 is preferably 250 mm, more preferably 200 mm, and still more preferably 150 mm. When the average horizontal diameter of the bubbles is below the lower limit, there is a risk that the hollow fiber membranes 11 cannot be sufficiently effectively cleaned. When the average horizontal diameter of the bubbles is above the upper limit, the bubbles will be too large and the number of bubbles will be reduced. Accordingly, there is a risk that the cleaning efficiency will be insufficient. In addition, there is also a risk that the bubbles will break while moving upward and that the rising paths thereof will be unstable. The coarse bubbles supplied by the air bubble generation modules 2 may have various shapes, such as a circular shape or an elliptical shape, in a horizontal cross section. In the case where the bubbles have an elliptical shape in a horizontal cross section, the lower limit of the average major-axis diameter of the bubbles in a horizontal direction is preferably 10 mm, more preferably 20 mm, and still more preferably 50 mm. The upper limit of the average major-axis diameter is preferably 250 mm, more preferably 200 mm, and still more preferably 150 mm.

The shape of the bubble discharge holes 21 in the air bubble generation modules 2 is not particularly limited, and may be, for example, a circular shape, an elliptical shape, or a rectangular shape. When the bubble discharge holes 21 in the air bubble generation modules 2 of the filter unit have a circular shape, an elliptical shape, or a rectangular shape, the bubble discharge holes 21 capable of supplying coarse bubbles can be relatively easily formed. In particular, the bubble discharge holes 21 preferably have an oblong shape. In the filter unit, when the bubble discharge holes 21 have an oblong shape, the hollow fiber membranes 11 can be more effectively cleaned by, for example, arranging the bubble discharge holes 21 so that the long sides of the bubble discharge holes are parallel to an arrangement direction in which the hollow fiber membranes 11 are arranged (long-axis direction of the region in which the hollow fiber membranes 11 are present).

In the case where the bubble discharge holes 21 have an oblong shape, the lower limit of the length of the long sides of the bubble discharge holes 21 is preferably 20 mm, and more preferably 30 mm. The upper limit of the length of the long sides of the bubble discharge holes 21 is preferably 60 mm, and more preferably 50 mm. When the length of the long sides is below the lower limit, the length of the short sides need to be relatively long to discharge coarse bubbles. Accordingly, there is a risk that each air bubble generation module 2 cannot be easily disposed between adjacent filtration modules 1. When the length of the long sides is above the upper limit, in the case where the bubble discharge holes 21 are arranged so that the long sides thereof are parallel to the arrangement direction of the hollow fiber membranes 11, a sufficient number of bubble discharge holes 21 cannot be arranged in the arrangement direction, and there is a risk that the hollow fiber membranes 11 cannot be sufficiently effectively cleaned.

In the case where the bubble discharge holes 21 have an oblong shape, the lower limit of the ratio of the length of the long sides of the bubble discharge holes 21 to the length of the short sides of the bubble discharge holes 21 is preferably 2, more preferably 3, and still more preferably 3.5. The upper limit of the ratio is preferably 8, more preferably 6, and still more preferably 5. When the ratio is below the lower limit, there is a risk that each air bubble generation module 2 cannot be easily disposed between adjacent filtration modules 1. When the ratio is above the upper limit, there is a risk that the bubbles will easily break while moving upward.

In the filter unit, preferably, the length of the long sides of the bubble discharge holes 21 and the ratio of the length of the long sides of the bubble discharge holes 21 to the length of the short sides of the bubble discharge holes 21 are both in the above-described ranges. In such a case, in the filter unit, the coarse bubbles can be easily and reliably brought into contact with the surfaces of the hollow fiber membranes 11, and the hollow fiber membranes 11 can be more effectively cleaned.

As described above, the bubble discharge holes 21 may instead have a circular shape or an elliptical shape. In such a case, the lower limit of the average diameter of the bubble discharge holes 21 in the air bubble generation modules 2 is preferably 10 mm, more preferably 15 mm, and still more preferably 20 mm. The upper limit of the average diameter of the bubble discharge holes 21 in the air bubble generation modules 2 is preferably 50 mm, more preferably 45 mm, and still more preferably 40 mm. When the average diameter of the bubble discharge holes 21 in the air bubble generation modules 2 is below the lower limit, sufficiently large bubbles cannot be discharged, and there is a risk that the surfaces of the hollow fiber membranes 11 cannot be appropriately abraded by the bubbles discharged from the bubble discharge holes 21 in the air bubble generation modules 2. When the average diameter of the bubble discharge holes 21 in the air bubble generation modules 2 is above the upper limit, the bubbles will be too large and the number of bubbles will be reduced. Accordingly, there is a risk that the cleaning efficiency will be insufficient. In addition, there is also a risk that the bubbles will break while moving upward and that the rising paths thereof will be unstable.

The lower limit of the area S of the bubble discharge holes 21 is preferably 100 mm², more preferably 200 mm², and still more preferably 300 mm². The upper limit of the area S of the bubble discharge holes 21 is preferably 1000 mm², more preferably 800 mm², and still more preferably 600 mm². When the area S of the bubble discharge holes 21 is below the lower limit, sufficiently large bubbles cannot be discharged, and there is a risk that the surfaces of the hollow fiber membranes 11 cannot be appropriately abraded by the bubbles discharged from the bubble discharge holes 21 in the air bubble generation modules 2. When the area S of the bubble discharge holes 21 is above the upper limit, the bubbles will be too large and the number of bubbles will be reduced. Accordingly, there is a risk that the cleaning efficiency will be insufficient. In addition, there is also a risk that the bubbles will break while moving upward and that the rising paths thereof will be unstable.

In the filter unit, the diffuser tubes 4 are arranged so as to overlap the air bubble generation modules 2 in plan view. When the filter unit has such a configuration, the gas discharged from the diffuser tubes 4 can be easily and reliably introduced into the air bubble generation modules 2. In addition, in the filter unit, the bubbles can be easily and reliably supplied to the surfaces of all of the hollow fiber membranes 11 included in the pair of adjacent filtration modules 1 by discharging the bubbles from the bubble discharge holes 21 in the air bubble generation modules 2 that extend continuously.

(Diffuser Tubes)

The diffuser tubes 4 include straight tube portions whose axes extend in a direction parallel to the filtration modules 1 (Y direction). The straight tube portions are disposed beneath the air bubble generation modules 2. The diffuser tubes 4 each have a plurality of diffusion holes arranged in the axial direction of the straight tube portions. The diffusion holes are disposed beneath the air bubble generation modules 2. The diffuser tubes 4 are configured so that gas is introduced into each diffuser tube 4 from one end thereof and discharged through the diffusion holes and that the discharged gas can be introduced into the air bubble generation modules 2.

(Filtration Modules)

As illustrated in FIG. 2, the filtration modules 1 are arranged in the transverse direction (X direction) and in the longitudinal direction (Y direction) at equal intervals.

The lower limit of the average interval between the filtration modules 1 (average interval between the lower holding members 13) that are adjacent to each other in the transverse direction (X direction) D₁ is preferably 15 mm, and more preferably 18 mm. The upper limit of the average interval D₁ between the filtration modules 1 that are adjacent to each other in the transverse direction is preferably 30 mm, and more preferably 25 mm. When the average interval D₁ of the filtration modules 1 that are adjacent to each other in the transverse direction is below the lower limit, the bubbles discharged from the air bubble generation modules 2 cannot easily move through the gaps between the adjacent filtration modules 1, and there is a risk that sufficient cleaning effect cannot be provided by the bubbles discharged from the bubble discharge holes 21 in the air bubble generation modules 2. When the average interval D₁ between the filtration modules 1 that are adjacent to each other in the transverse direction is above the upper limit, the bubble discharge holes 21 in the air bubble generation modules 2 are spaced from the hollow fiber membranes 11 by a large distance in a horizontal direction, and there is a risk that sufficient cleaning effect cannot be provided by the bubbles discharged from the bubble discharge holes 21 in the air bubble generation modules 2. In addition, when the average interval D₁ is above the upper limit, there is a risk that the filter unit will be unnecessarily large.

The lower limit of the ratio (S/D₁) of the area S [mm²] of the bubble discharge holes 21 to the average interval D₁ [mm] between the filtration modules 1 that are adjacent to each other in the transverse direction is preferably 5, and more preferably 10. The upper limit of the ratio (S/D₁) is preferably 50, and more preferably 30. When the ratio (S/D₁) is below the lower limit, the diameter of the bubbles discharged from the bubble discharge holes 21 will be too small relative to the average interval D₁ between the filtration modules 1 that are adjacent to each other in the transverse direction, and there is a risk that the surfaces of the hollow fiber membranes 11 cannot be appropriately abraded by the bubbles discharged from the bubble discharge holes 21 in the air bubble generation modules 2. When the ratio (S/D₁) is above the upper limit, the bubbles will be too large and the number of bubbles will be reduced. Accordingly, there is a risk that the cleaning efficiency will be insufficient. In addition, there is also a risk that the bubbles will break while moving upward and that the rising paths thereof will be unstable.

(Hollow Fiber Membranes)

The hollow fiber membranes 11 are tubes formed of porous membranes that allow liquid to permeate therethrough and prevent impurities contained in the untreated liquid from permeating therethrough.

The hollow fiber membranes 11 may contain a thermoplastic resin as a main component thereof. Examples of the thermoplastic resin include polyethylene, polypropylene, polyvinylidene fluoride, ethylene-vinyl alcohol copolymers, polyamide, polyimide, polyetherimide, polystyrene, polysulfone, polyvinyl alcohol, polyphenylene ether, polyphenylene sulfide, cellulose acetate, polyacrylonitrile, and polytetrafluoroethylene (PTFE). Among these, PTFE, which is excellent in terms of mechanical strength, chemical resistance, heat resistance, weather resistance, flame resistance, etc., and which is porous, is preferable, and uniaxially or biaxially expanded PTFE is more preferable. The material of the hollow fiber membranes 11 may contain, for example, other polymers and additives such as a lubricant as appropriate.

The lower limit of the average outer diameter of the hollow fiber membranes 11 is preferably 1 mm, more preferably 1.5 mm, and still more preferably 2 mm. The upper limit of the average outer diameter of the hollow fiber membranes 11 is preferably 6 mm, more preferably 5 mm, and still more preferably 4 mm. When the average outer diameter of the hollow fiber membranes 11 is below the lower limit, there is a risk that the mechanical strength of the hollow fiber membranes 11 will be insufficient. When the average outer diameter of the hollow fiber membranes 11 is above the upper limit, the flexibility of the hollow fiber membranes 11 will be insufficient, and sufficient vibration and titubation of the hollow fiber membranes 11 cannot be caused by the gas that comes into with the hollow fiber membranes 11. Accordingly, there is a risk that the gaps between the hollow fiber membranes 11 cannot be increased enough to guide the gas therethrough. There is also a risk that the filtration efficiency will be reduced due to a reduction in the ratio of the surface area to the cross sectional area of the hollow fiber membranes 11.

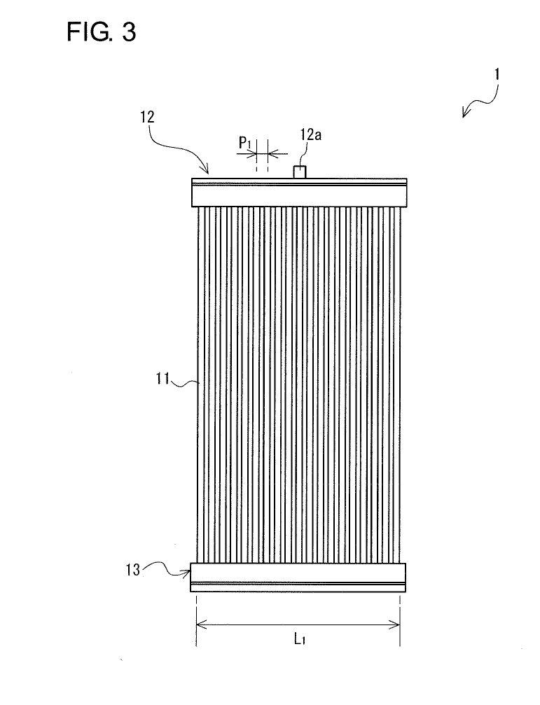

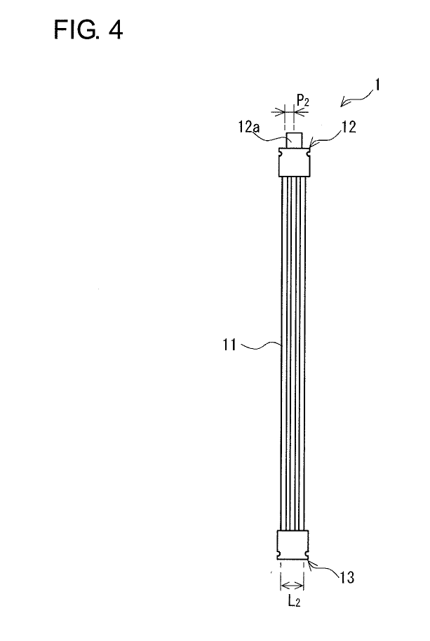

As illustrated in FIGS. 3 and 4, in each filtration module 1, the hollow fiber membranes 11 are arranged at equal intervals in the longitudinal direction and the transverse direction in plan view, so that a bundle of hollow fiber membranes 11 arranged at a substantially uniform density is held by the upper holding member 12 and the lower holding member 13. In other words, in each filtration module 1, the gaps between the hollow fiber membranes 11 have the same size, and there are no small gaps or large gaps. When the gaps between the hollow fiber membranes 11 are uniform as described above, uneven distribution of the rising paths of the bubbles can be prevented, and reduction in the cleaning performance in local areas can be prevented accordingly. The intervals between the hollow fiber membranes 11 in the longitudinal direction may differ from the intervals between the hollow fiber membranes 11 in the transverse direction.

The number of hollow fiber membranes 11 arranged in the longitudinal direction in each filtration module 1 (number of rows) may be, for example, in a range from 10 to 1000. The number of hollow fiber membranes 11 arranged in the transverse direction (number of columns) may be, for example, in a range from 2 to 100.

The lower limit of the existence density of the hollow fiber membranes 11 in each filtration module 1 is preferably 4 per square centimeter, more preferably 5 per square centimeter, and still more preferably 7 per square centimeter. The upper limit of the existence density of the hollow fiber membranes 11 is preferably 15 per square centimeter, more preferably 12 per square centimeter, and still more preferably 10 per square centimeter. When the existence density of the hollow fiber membranes 11 is below the lower limit, there is a risk that the filtration efficiency will be insufficient. When the existence density of the hollow fiber membranes 11 is above the upper limit, there is a risk that the bubbles discharged from the bubble discharge holes 21 in the air bubble generation modules 2 cannot be appropriately supplied to the central portions of the bundles of the hollow fiber membranes 11.

The lower limit of the average length of the bundles of the hollow fiber membranes 11 in the longitudinal direction in a cross section perpendicular to the up-down direction (average length in the Y direction) L₁ is preferably 300 mm, and more preferably 500 mm. The upper limit of the average length L₁ of the bundles of the hollow fiber membranes 11 in the longitudinal direction is preferably 1200 mm, and more preferably 1000 mm. When the average length L₁ of the bundles of the hollow fiber membranes 11 in the longitudinal direction is below the lower limit, there is a risk that the filtration efficiency will be insufficient. When the average length L₁ of the bundles of the hollow fiber membranes 11 in the longitudinal direction is above the upper limit, there is a risk that handling of the filtration modules 1 will be difficult.

The lower limit of the average length of the bundles of the hollow fiber membranes 11 in a direction perpendicular to the long axis thereof (transverse direction) in the cross section perpendicular to the up-down direction (average length in the X direction) L₂ is preferably 10 mm, and more preferably 15 mm. The upper limit of the average length L₂ of the bundles of the hollow fiber membranes 11 in the transverse direction is preferably 100 mm, and more preferably 75 mm. When the average length L₂ of the bundles of the hollow fiber membranes 11 in the transverse direction is below the lower limit, there is a risk that the filtration efficiency will be insufficient. When the average length L₂ of the bundles of the hollow fiber membranes 11 in the transverse direction is above the upper limit, there is a risk that the bubbles discharged from the bubble discharge holes 21 in the air bubble generation modules 2 cannot be appropriately supplied to the central portions of the bundles of the hollow fiber membranes 11.

The lower limit of the ratio (L₂/L₁) of the average length L₂ in the transverse direction to the average length L₁ in the longitudinal direction is preferably 1/80, and more preferably 1/50. The upper limit of the ratio (L₂/L₁) of the average length L₂ to the average length L₁ is preferably 1/3, and more preferably 1/10. When the ratio (L₂/L₁) of the average length L₂ to the average length L₁ is below the lower limit, there is a risk that handling of the filtration modules 1 will be difficult. When the ratio (L₂/L₁) of the average length L₂ to the average length L₁ is above the upper limit, there is a risk that the bubbles discharged from the bubble discharge holes 21 in the air bubble generation modules 2 cannot be appropriately supplied to the central portions of the bundles of the hollow fiber membranes 11.

The average pitch P1 of the hollow fiber membranes 11 in the longitudinal direction (Y direction) in a cross section perpendicular to the up-down direction is preferably greater than the average pitch P2 of the hollow fiber membranes 11 in the transverse direction (X direction). The lower limit of the ratio (P2/P1) of the average pitch P2 of the hollow fiber membranes 11 in the transverse direction to the average pitch P1 of the hollow fiber membranes 11 in the longitudinal direction is preferably 2/5, and more preferably 1/2. The upper limit of the ratio (P2/P1) of the average pitch P2 of the hollow fiber membranes 11 in the transverse direction to the average pitch P1 of the hollow fiber membranes 11 in the longitudinal direction is preferably 4/5, and more preferably 2/3. When the ratio (P2/P1) is below the lower limit, the density of the hollow fiber membranes 11 in the longitudinal direction will be too low, and there is a risk that the filtration efficiency will be insufficient. When the ratio (P2/P1) is above the upper limit, there is a risk that the bubbles discharged from the bubble discharge holes 21 in the air bubble generation modules 2 cannot be appropriately supplied to the central portions of the bundles of the hollow fiber membranes 11.

The lower limit of the average effective length of the hollow fiber membranes 11 (average length of the hollow fiber membranes 11 between the bottom ends of the upper holding members 12 and the top ends of the lower holding members 13) is preferably 1 m, and more preferably 2 m. The upper limit of the average effective length of the hollow fiber membranes 11 is preferably 6 m, and more preferably 5 m. When the average effective length of the hollow fiber membranes 11 is below the lower limit, there is a risk that the titubation of the hollow fiber membranes 11 caused by the abrasion by the bubbles will be insufficient, and the gaps between the hollow fiber membranes 11 cannot be increased enough to guide the gas therethrough. When the average effective length of the hollow fiber membranes 11 is above the upper limit, there is a risk that the fiber membranes 11 will be excessively bent due to the weight thereof and that the filtration modules 1 cannot be easily handled when, for example, the filtration modules 1 are attached or removed.

(Upper Holding Members)

Each upper holding member 12 has an internal space that communicates with hollow portions of the hollow-fiber membranes 11 held by the upper holding member 12, and is provided with a drain nozzle 12a that discharges the treated liquid that has been filtered by the hollow-fiber membranes 11 from the internal space. Each upper holding member 12 has a rectangular parallelepiped shape having a longitudinal direction in the long-axis direction of the bundle of the hollow fiber membranes 11 (Y direction), a transverse direction in a direction perpendicular to the long axis of the bundle of the hollow fiber membranes 11 (X direction), and a height direction in the up-down direction (Z direction).

(Lower Holding Members)

Each lower holding member 13 may either have an internal space similar to that of each upper holding member 12 or hold the bottom ends of the hollow fiber membranes 11 so as to block the openings in the hollow fiber membranes 11. Each lower holding member 13 has a rectangular parallelepiped shape having a longitudinal direction in the long-axis direction of the bundle of the hollow fiber membranes 11 (Y direction), a transverse direction in a direction perpendicular to the long axis of the bundle of the hollow fiber membranes 11 (X direction), and a height direction in the up-down direction (Z direction).

The lower limit of the ratio of the average length of the lower holding members 13 in the transverse direction (average length in the X direction) to the average length of the bundles of the hollow fiber membranes 11 in the transverse direction (average length in the X direction) is preferably 1.05, and more preferably 1.1. The upper limit of the ratio is preferably 1.3, and more preferably 1.2. When the ratio is below the lower limit, there is a risk that the bottom ends of the hollow fiber membranes 11 cannot be appropriately fixed to the lower holding members 13. When the ratio is above the upper limit, there is a risk that the bubbles discharged from the bubble discharge holes 21 in the air bubble generation modules 2 cannot be appropriately supplied to the hollow fiber membranes 11. The ratio of the average length of the upper holding members 12 in the transverse direction (average length in the X direction) to the average length of the bundles of the hollow fiber membranes 11 in the transverse direction (average length in the X direction) may be equivalent to the ratio of the average length of the lower holding members 13 in the transverse direction to the average length of the bundles of the hollow fiber membranes 11 in the transverse direction.

(Frame)

The frame 3 includes a plurality of round bars 31 that retain the side surfaces of the upper holding members 12 and the lower holding members 13 of the filtration modules 1. The frame 3 holds the filtration modules 1 by retaining the side surfaces of the upper holding members 12 and the lower holding members 13 of the filtration modules 1 with the round bars 31. The frame 3 also holds the air bubble generation modules 2. The method by which the frame 3 holds the air bubble generation modules 2 is not particularly limited. For example, the air bubble generation modules 2 that extend continuously in the direction parallel to the filtration modules 1 (Y direction) may be held individually. Alternatively, the air bubble generation modules 2 that are connected and fixed together may be held collectively.

Preferably, no member that blocks an upward movement of the bubbles is provided between the filtration modules of the filter unit. In other words, preferably, the filter unit does not include any member that blocks the upward movement of the bubbles in the spaces between the upper holding members 12, between the lower holding members 13, and between the bundles of the hollow fiber membranes 11 of the filtration modules 1 that are adjacent to each other in the transverse direction (X direction). Examples of the blocking member include plate-shaped members and rod-shaped members that extend between the filtration modules 1. The hollow fiber membranes 11 that are closer to the outer periphery of each filtration module 1 more easily allow the impurities to adhere thereto. Therefore, when vertical rising paths for the bubbles that do not block the upward movement of the bubbles are formed between the filtration modules 1, the hollow fiber membranes 11 at the outer periphery of each filtration module 1 can be efficiently cleaned by the coarse bubbles. In addition, when there is no blocking member, the bubbles move vertically upward at substantially uniform intervals. Accordingly, non-uniform cleaning does not easily occur.

(Discharge Mechanism)

The discharge mechanism 5 is connected to the drain nozzles 12a of the filtration modules 1, and includes a collecting pipe 51 that collects the treated liquid that has been filtered and a suction pump 52 that sucks the treated liquid from the collecting pipe 51.

### OTHER EMBODIMENTS

It is to be understood that the embodiment disclosed herein is an example and not restrictive in all respects. The scope of the present invention is not limited by the configuration of the above-described embodiment but is defined by the claims, and is intended to include equivalents to the scope of the claims and all modifications within the scope of the claims.

The number of air bubble generation modules is not limited to two or more, and may instead be one. Also, the air bubble generation modules are not necessarily continuous in the direction parallel to the filtration modules (Y direction). The air bubble generation modules may instead be arranged at certain intervals in the direction parallel to the filtration modules.

The diffuser tubes are not necessarily disposed below the air bubble generation modules. For example, the diffuser tubes may instead be provided so as to extend through the air bubble generation modules.

The configurations of the upper holding members, the lower holding members, the hollow fiber membranes, the frame, the discharge mechanism, etc., of the filter unit are not limited to those described in the embodiment, and various configurations may be used.

The filter unit may be used as various types of filter devices such as an external pressure type filter device in which the pressure is increased at the outer peripheral surfaces of the hollow fiber membranes so that the untreated liquid permeates toward the inner peripheral surfaces of the hollow fiber membranes, an immersion type filter device in which the untreated liquid is caused to permeate toward the inner peripheral surfaces by an osmotic pressure or a negative pressure at the inner peripheral surfaces, and an internal pressure type filter device in which the pressure is increased at the inner peripheral surfaces of the hollow fiber membranes so that the untreated liquid permeates toward the outer peripheral surfaces of the hollow fiber membranes. In particular, the filter unit is suitable for use as an external pressure type filter device.

### REFERENCE SIGNS LIST

1 filtration module
2 air bubble generation module
3 frame
4 diffuser tube
5 discharge mechanism
11 hollow fiber membrane
12 upper holding member
12a drain nozzle
13 lower holding member
21 bubble discharge hole
31 round bar
51 collecting pipe
52 suction pump

1. A filter unit comprising:
a plurality of filtration modules which each include a plurality of hollow fiber membranes extending in an up-down direction and arranged side by side in a curtain shape and which are arranged at intervals; and
one or more air bubble generation modules that supply bubbles to the filtration modules from below,
wherein the one or more air bubble generation modules supply coarse bubbles to the filtration modules.

2. The filter unit according to claim 1, wherein no member that blocks an upward movement of the bubbles is provided between the filtration modules.

3. The filter unit according to claim 1, wherein an average horizontal diameter of the bubbles is in a range from 10 mm to 250 mm.

4. The filter unit according to claim 1, wherein the one or more air bubble generation modules have bubble discharge holes having a circular shape, an elliptical shape, or a rectangular shape.

5. The filter unit according to claim 4, wherein the bubble discharge holes have an oblong shape.

6. The filter unit according to claim 5, wherein a length of long sides of the bubble discharge holes is in a range from 20 mm to 60 mm, and a ratio of the length of the long sides to a length of short sides of the bubble discharge holes is in a range from 2 to 8.

7. The filter unit according to claim 4, wherein the bubble discharge holes have a circular shape or an elliptical shape, and an average diameter of the bubble discharge holes of the one or more air bubble generation modules is in a range from 10 mm to 50 mm.

8. The filter unit according to claim 1, wherein the one or more air bubble generation modules supply the bubbles intermittently.

9. The filter unit according to claim 1, wherein the filtration modules are arranged at equal intervals at least in a transverse direction, and an average interval between the filtration modules that are adjacent to each other in the transverse direction is in a range from 15 mm to 30 mm.

10. The filter unit according to claim 1, wherein an existence density of the hollow fiber membranes included in the filtration modules is in a range from 4 per square centimeter to 15 per square centimeter.
